(19) United States
(12) Patent Application Publication
(10) Pub. No.: US 2025/0217258 A1
(43) Pub. Date: Jul. 3, 2025

(54) AI-DRIVEN SECTION-BY-SECTION TEST STRATEGY GENERATION

(71) Applicant: SAP SE, Walldorf (DE)

(72) Inventor: Lamine Rihani, Sartrouville (FR)

(21) Appl. No.: 18/918,392

(22) Filed: Oct. 17, 2024

Related U.S. Application Data
(60) Provisional application No. 63/616,032, filed on Dec. 29, 2023.

(51) Int. Cl. G06F 11/34; G06F 11/36

(52) U.S. Cl. CPC G06F 11/3466; G06F 11/3684; G06F 11/3688

(57) ABSTRACT

Methods, systems, and apparatus, including medium-encoded computer program products for executing a test strategy, include: receiving a request to generate a test strategy for a new feature of a software solution; consecutively generating one or more sections defined at a test strategy template for the test strategy, wherein consecutively generating the one or more sections comprises: invoking, for each section, a large language model in a conversational mode for generating test strategy data for each section of the test strategy template; generating a specification of the test strategy by concatenating the sections defined in the test strategy template; and executing the generated test strategy for the new feature of the software solution to obtain output data, the output data including monitoring data for performance of the new features, wherein the performance is determined based on criteria of the generated test strategy.

### CLAIM OF PRIORITY

This application claims priority to and under 35 USC § 119 (e) to the U.S. Provisional Patent Application No. 63/616,032, filed Dec. 29, 2023, the entire contents of which are hereby incorporated by reference.

### TECHNICAL FIELD

The present disclosure relates to computer-implemented methods, software, and systems for data processing.

### BACKGROUND

Software complexity is increasing and causes changes to the lifecycle management and maintenance of software applications, databases, and platform systems. In software development, testing software products and their functionality usually is associated with complicated systems and/or processes that require time and resources to ensure high quality results. Usually, quality engineers define, generate, and execute tests for software solutions with a great variety of combinations to cover different use case scenarios and perform a comprehensive quality evaluation of the system and/or solutions.

### SUMMARY

Implementations of the present disclosure are generally directed to computer-implemented methods for the automatic generation of test strategies or test scripts to support quality assurance processes executed for a software solution or product.

In a first general aspect, this specification can be embodied in one or more methods (and also one or more non-transitory computer-readable mediums tangibly encoding a computer program operable to cause data processing apparatus to perform operations), including: receiving a request to generate a test strategy for a new feature of a software solution, wherein the received request includes a specification of the new feature; generating the test strategy by executing a large language model to automatically generate one or more test strategies based on technical documentation for the software solution, a test strategy template, and legacy test strategies defined for the software solution; and executing the generated test strategy for the new feature of the software solution to obtain output data, the output data including monitoring data for the performance of the new feature, the performance of the new feature being determined based on criteria of the generated test strategy.

In a second general aspect, this specification can be embodied in one or more methods (and also one or more non-transitory computer-readable mediums tangibly encoding a computer program operable to cause data processing apparatus to perform operations), including: receiving a request to generate a test strategy for a new feature of a software solution, wherein the received request includes a specification of the new feature; consecutively generating one or more sections defined at a test strategy template for the test strategy, wherein consecutively generating the one or more sections comprises: invoking, for each section, a large language model in a conversational mode for generating test strategy data for each section of the test strategy template, wherein invoking the large language model comprises providing data comprising technical documentation relevant for the respective section, data for the respective section from legacy strategies, and requests relevant to the respective section as defined in the test strategy template; generating a specification of the test strategy by concatenating the sections defined in the test strategy template; and executing the generated test strategy for the new feature of the software solution to obtain output data, the output data including monitoring data for performance of the new features, wherein the performance is determined based on criteria of the generated test strategy.

In a third general aspect, this specification can be embodied in one or more methods (and also one or more non-transitory computer-readable mediums tangibly encoding a computer program operable to cause data processing apparatus to perform operations), including: receiving a request to generate a test script for a new test strategy defined for a software solution, wherein the received request includes a specification of the new test strategy; generating the test script based on executing a large language model that receives as input of the specification of the new test strategy, wherein the large language model is trained to automatically generate test scripts based on technical documentation for a testing framework defined for the software solution and integration tests generated for the software solution; executing the test script for the new test strategy to obtain output data, and the output data including performance data for the software solution.

In a fourth general aspect, this specification can be embodied in one or more methods (and also one or more non-transitory computer-readable mediums tangibly encoding a computer program operable to cause data processing apparatus to perform operations), including: receiving a request to generate a test script for issues reproduction for a software solution, wherein the received request includes a specification of an issue; generating the test script based on executing a large language model that is trained to automatically generate test scripts based on technical documentation for a testing framework defined for the software solution, integration tests generated for the software solution, technical documentation for the software solution, and previously reported issues for at least one previous or current version of the software solution; and executing the test script for the issue reproduction to reproduce the issue on a particular version of the software solution to obtain output data including performance data for the particular version of the software solution.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description, drawings, and the claims.

### BRIEF DESCRIPTION OF DRAWINGS

FIG. 1 depicts an example system that can execute implementations of the present disclosure.

FIG. 2A shows a block diagram for a software quality assurance process applying AI techniques in accordance with implementations of the present disclosure.

FIG. 2B shows a block diagram for an example of a process for executing a test strategy to test performance of a new feature of a software solution in accordance with implementations of the present disclosure.

FIG. 3A shows a block diagram for an example of a test generated based on a large language model package in accordance with implementations of the present disclosure.

FIG. 3B shows a block diagram including an example of a process for generating a test strategy section by section based on invoking a large language model in accordance with implementations of the present disclosure.

FIG. 3C is an example process for generating a test strategy in a section-by-section mode in accordance with implementations of the present disclosure.

FIG. 4A shows a block diagram of an example automatic test script generation process.

FIG. 4B shows a block diagram of an example execution of a test strategy based a test script that is generated based on invoking a large language model in accordance with implementations of the present disclosure.

FIG. 5 shows a block diagram of an example test script generation process for bug reproduction.

FIG. 6 is a schematic illustration of example computer systems that can be used to execute implementations of the present disclosure.

### DETAILED DESCRIPTION

In software development, ensuring the reliability and effectiveness of software application(s) or product(s) is very important. Quality Assurance (QA) plays a central role in this process, where the QA includes steps for validating that the software application(s) or product(s) meets predefined criteria and functions as expected (e.g., in accordance with a product specification). In some instances, the quality assurance process includes test case generation that involves creating a set of scenarios to validate various aspects of the software application(s) or product(s), including its functional features. This process traditionally demands significant time and manual effort from QA engineers to design effective test cases.

In some cases, a manual approach for generating test strategies can be inefficient in providing comprehensive test strategies that cover various aspects of the functionality of the software solution being tested and can be error prone. As software becomes more sophisticated and multifaceted, testing every functional feature comprehensively becomes increasingly time-consuming. In some instances, software development and fast release cycles require test case generation to be performed at a matching pace. However, current manual test case generation struggles to keep pace with the rapid development and release cycles, resulting in a bottleneck where the speed of testing cannot match the velocity of development. Consequently, software releases that have to be provided after quality assurance (e.g., based on manual test generation) may face delays, compromising the competitive edge and market responsiveness of the product. Moreover, manual test case creation can be prone to human error, leading to inaccuracies and gaps in the test coverage. Inconsistent test cases may result in a skewed assessment of the software's quality, potentially missing critical performance issues. These oversights, when undetected, can lead to consequences at the production usage of the software when deployed. Poor quality of software products can impact user experience, provided quality of output data, and/or execution time for performing tasks that can reduce the service level provided by a software product.

In some instances, artificial intelligence (AI) techniques can be used for automated test case generation. A machine learning model can be trained to automatically generate test strategies for testing that can provide comprehensive coverage of functional features provided by the software solution being tested. In some instances, the machine learning model can be a large language model that can be trained to generate test cases for different software features. By leveraging large language models (LLM) techniques as a foundational technology for the test case generation, the model can be trained using extensive product documentation associated with the tested product or solution (e.g., system, application, service, product suite, etc.). The training allows the model to acquire an in-depth understanding of the diverse features present in the solution.

In some instances, the model can be trained using a designed template encompassing legacy test strategies and their associated product specifications, thus, providing valuable insights into effective testing methodologies. In some instances, the trained model can generate structured test strategies in a desired format (e.g., a predefined format or a user defined format that can be provided as part of the training or requested upon requesting to generate the test structure). When provided with a specification for a new feature(s), the model can intelligently produce detailed test strategies, significantly reducing the manual effort required for test case creation. This transformative approach promises to streamline the test case generation process, enhancing efficiency and ultimately leading to higher quality assurance standards within the development landscape of the tested system or product.

In parallel development scenarios, where multiple teams work on different components or features of the software simultaneously, coordinating and aligning testing efforts is another challenge. Ensuring that all features, especially the interactions between them, are thoroughly tested necessitates a level of synchronization and coordination that manual methods often struggle to achieve. The magnitude of this challenge amplifies with the size and complexity of the application.

Efficiently managing resources is a key concern for any organization. Traditional manual test case creation often ties down valuable QA human resources that could be better utilized in critical thinking, exploratory testing, or addressing complex scenarios. Automating the test case generation process becomes imperative to free up QA experts for higher-level tasks and optimize resource allocation, enhancing the overall efficiency of the QA process.

In some implementations, the solution to these challenges lies in automating the test strategy and test case generation process. Utilizing AI techniques, for example, Large Language Models (LLMs), holds immense promise. These models, having been trained on vast amounts of diverse text, can comprehend the complex language of software development, including technical specifications, feature requirements, and test strategies.

In some instances, generative AI techniques can be leveraged into test generation processes for enhancing software quality engineering processes. For example, a large language model can be optimized for a particular software product or solution, such as an analytical cloud application. In some instances, the language model can be trained based on specific training data for the particular software product or solution that includes documentation, test strategies, and automated tests, among other examples to automatically generate test strategies that are accurately yet efficiently generated based on fine-tuning a language model to a particular field and topic (e.g., quality assurance based on particular test specifics and for a particular product). Thus, such test strategy generation provides a better functional coverage when testing software products (e.g., new products as a whole or new features of existing products), which could lead to a better code coverage after automation and optimize the QA resource usage.

In some instances, the disclosed techniques enhance the quality and depth of testing strategies. AI-driven test strategy generation can accelerate the planning phase, aligning with our efficiency goals and enabling quicker adaptation to agile development cycles. By leveraging AI to generate comprehensive test strategies, products are rigorously tested, their quality and reliability is enhanced and verified, and high-quality deliverables can be provided to customers.

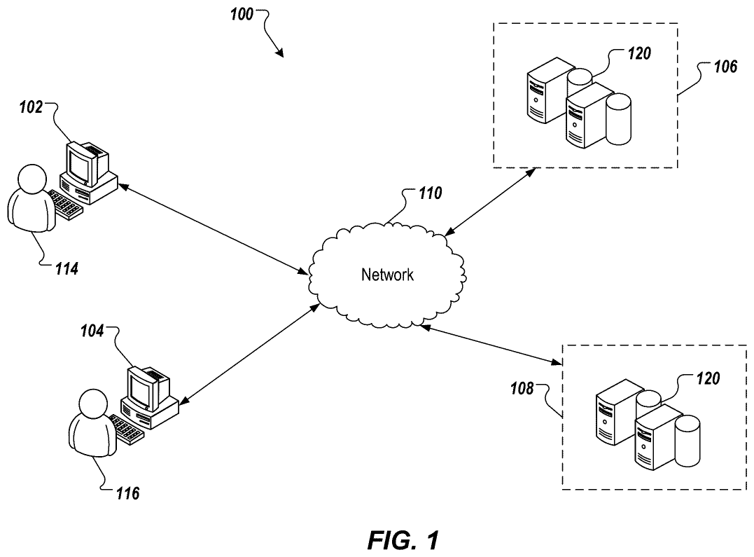

FIG. 1 depicts an example architecture 100 in accordance with implementations of the present disclosure. In the depicted example, the example architecture 100 includes a client device 102, a client device 104, a network 110, a cloud environment 106, and a cloud environment 108. The cloud environment 106 may include one or more server devices and databases (e.g., processors, memory). In the depicted example, a user 114 interacts with the client device 102, and a user 116 interacts with the client device 104.

In some examples, the client device 102 and/or the client device 104 can communicate with the cloud environment 106 and/or cloud environment 108 over the network 110. The client device 102 can include any appropriate type of computing device, for example, a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 110 can include a large computer network, such as a local area network (LAN), a wide area network (WAN), the Internet, a cellular network, a telephone network (e.g., PSTN), or an appropriate combination thereof connecting any number of communication devices, mobile computing devices, fixed computing devices and server systems.

In some implementations, the cloud environment 106 includes at least one server and at least one data store 120. In the example of FIG. 1, the cloud environment 106 is intended to represent various forms of servers including, but not limited to, a web server, an application server, a proxy server, a network server, and/or a server pool. In general, server systems accept requests for application services and provides such services to any number of client devices (e.g., the client device 102 over the network 110).

In accordance with implementations of the present disclosure, and as noted above, the cloud environment 106 can host applications and databases running on host infrastructure. In some instances, the cloud environment 106 can include multiple cluster nodes that can represent physical or virtual machines. A hosted application and/or service can run on virtual machines (VMs) hosted on cloud infrastructure. In some instances, one application and/or service can run as multiple application instances on multiple corresponding VMs, where each instance is running on a corresponding VM.

In some instances, such hosted applications or services running in the cloud environment 106 can be tested for example, based on automatically generated test cases in accordance with the present disclosure.

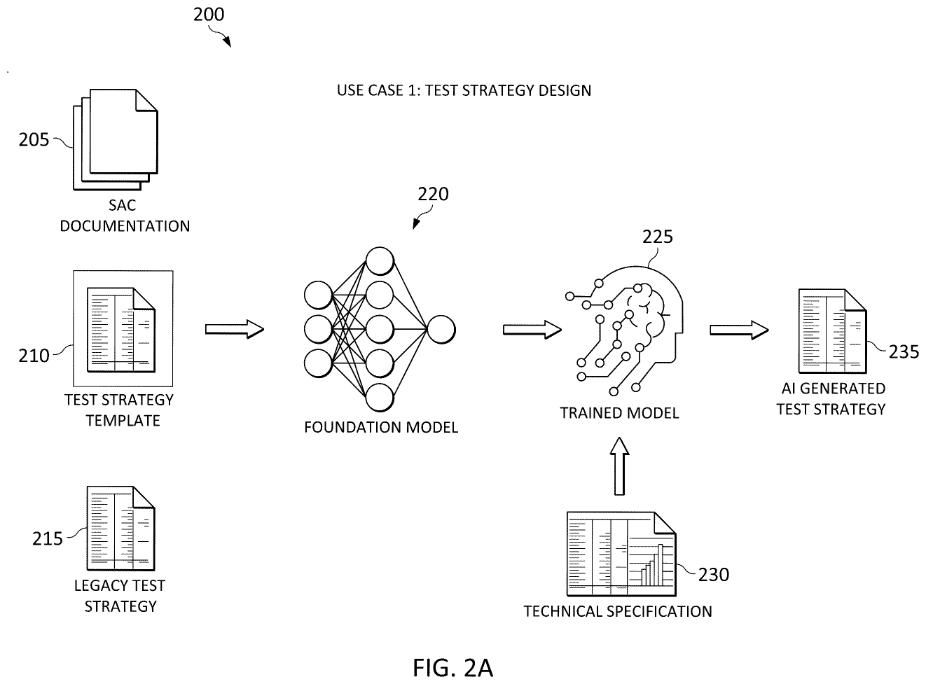

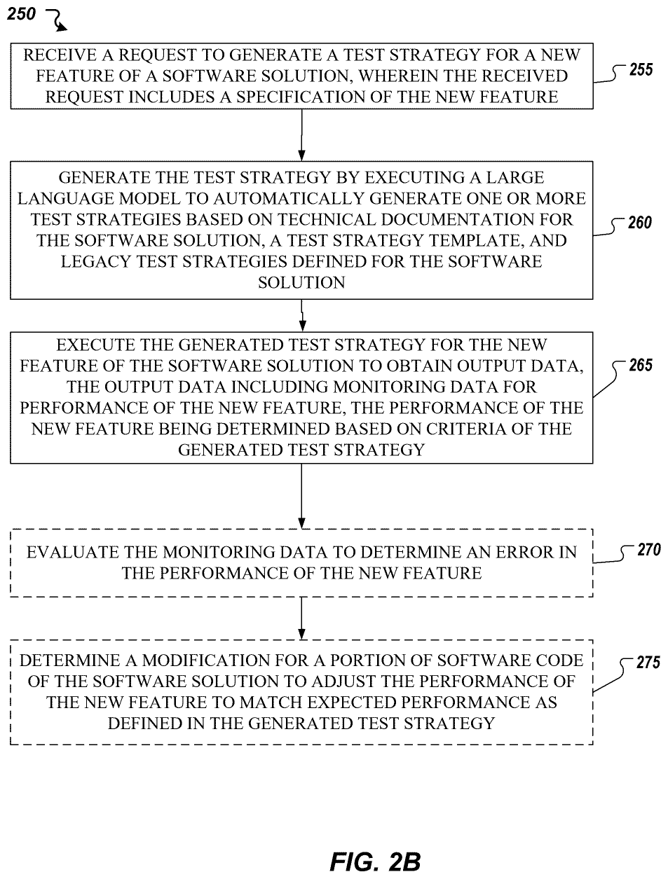

FIG. 2A shows a block diagram for a software quality assurance process applying AI techniques in accordance with implementations of the present disclosure. In response to the challenges imposed by manual test strategy generation and the need for improving the efficiency in performing comprehensive testing in modern software development, an innovative technical solution leveraging Generative Pre-trained Transformer (GPT) Language Models (LLMs) for automated test strategy generation is provided. For example, GPT-3.5 Turbo is an exemplary LLM that can be used as a foundation for generating test cases in a more efficient and comprehensive way.

In some instances, a large language model (such as GPT LLM) can be trained on a diverse corpus of text including 1) product documentation for the particular application or product that are to be tested and 2) a collection of legacy test strategies used by quality engineers. The training data can include a broad spectrum of language constructs, technical jargon, product specifications, and historical test strategies, among other examples. In some instances, a diverse dataset used for the training can ensure that the model comprehensively understands the intricacies of the solution (application or product) and the context in which it is developed and tested.

In some instances, the training process includes fine-tuning of a particular large language model (e.g., GPT-3.5 Turbo model) on a specialized dataset generated for the training. In some instances, the fine-tuning can improve the model's understanding and make it specific to features, functionalities, and the desired test strategy format relevant for the solution being tested. In some instances, the fine-tuning can include steps to refine the model's ability to generate test strategies that are contextually accurate, relevant, and aligned with the expected testing outcomes for the product.

In some implementations, a large language package related to the software product can be generated by fine-tuning an input language model. In some instances, the fine-tuning can include adjusting of the obtaining language model as input (e.g., a base LLM) to understand and generate content specific to the tested solution. This process involves multiple iterations to ensure the model comprehensively learns the language nuances, technical terminology, and intricacies related to solution features (e.g., features of an application and/or services provided for consumption by an end-user or another application or service) and testing strategies.

In some instances, once the model is trained and fine-tuned, it is ready for the test strategy generation phase. The model takes a new feature's technical specification as input, provided in a structured format, and generates a detailed test strategy accordingly. The structured format ensures that the model understands the specific requirements, objectives, and parameters related to the new feature. The generated test strategy outlines the testing approach, methodologies, tools, and criteria necessary for comprehensive testing of the feature.

In some instances, to enhance the utility and clarity of the generated test strategy, the model is also trained on the desired format for the strategy document. This training ensures that the output aligns with the organization's preferred documentation style, making the generated strategies easily understandable and accessible to all stakeholders involved in the testing process. In some implementations, the generated test strategy can serve as a foundational document guiding the subsequent steps in the testing process. QA engineers, leveraging this AI-generated strategy, can then proceed to create detailed test cases, ensuring that the functional features are thoroughly tested. This AI-powered approach significantly expedites the entire test planning phase, empowering the QA team to focus more on critical thinking, exploratory testing, and addressing unique testing scenarios.

In some instances, human validation and oversight can also be integrated into the test strategy generation, execution, monitoring, and data evaluation. Although the GPT LLM significantly accelerates the test strategy creation process, human experts can review and refine the generated strategies to ensure accuracy, completeness, and relevance to the tested feature. In some instances, such user review and/or interaction can be requested based on predefined rules, where data for the user's input can be used for subsequent training of the language model and optimization of the model to be further fine-tuned based on such user input. In some instances, an iterative feedback loop can be defined between the AI and human experts, which can guarantee the highest quality and relevance of the generated test strategies.

Based on implementations of the present disclosure, test strategy generation processes for software solutions can be performed by utilizing language models trained for the particular solution, which can significantly enhance the efficiency and effectiveness of the software testing phase. By leveraging the model's understanding of product documentation and historical test strategies, we enable the creation of structured, tailored test strategies for each feature, ensuring comprehensive functional feature coverage in an agile and resource-optimized manner. This innovative approach propels software testing into a new era, driving efficiency, accuracy, and excellence in software quality assurance.

The present implementations for generating a large language model package that supports efficient and accurate test strategy generation provide multiple technical advantages. For example, a large language model package can be provided for a particular software solution that can be generated based on fine-tuning an input language model as a base (e.g., GPT language model). Such use of the large language model package can be considered a transformative leap in software Quality Assurance (QA). This innovative approach addresses critical challenges faced in modern software development and quality assurance.

The automated test strategy generation facilitated by the large language model package drastically accelerates the test planning phase. By automating a process that traditionally required significant manual effort, the solution expedites the generation of detailed and structured test strategies. This automation translates into a substantial reduction in the time taken to devise test strategies for new features, empowering the QA team to adapt swiftly to agile development cycles and faster release timelines.

The AI-driven test strategy generation ensures that the generated strategies encompass a comprehensive spectrum of functional features. By leveraging the model's understanding of the solution being tested (product or application) by providing documentation and historical test strategies, the generated test strategies cover a wide array of testing objectives and methodologies. This results in a more thorough and effective testing approach, significantly reducing the risk of undetected defects or critical issues, ultimately leading to higher software reliability and quality.

Further, standardization is a cornerstone of effective quality assurance. Implementations of the present solution support consistency in test strategy documentation by adhering to predefined formats and templates. The model is trained on the desired structure and style for test strategies, ensuring a standardized output that aligns with the organization's conventions and preferences. This standardization facilitates improved collaboration, comprehension, and maintenance of test strategies across the QA team.

Automating test strategy creation alleviates the workload on QA engineers, allowing them to dedicate more time and effort to higher-level tasks that require critical thinking and problem-solving abilities. The repetitive and time-consuming task of test strategy formulation is shifted to the AI, enabling QA experts to optimize their resources and focus on aspects that demand human intelligence, creativity, and domain expertise.

For example, Table 1 below presents an example test strategy.

TABLE 1

| Reference | Expectation | | |
|---|---|---|---|
| Is design | Yes | | |
| described well | | | |
| in User Story | | | |
| and well | | | |
| understood by | | | |
| implementatio | | | |
| n team? | | | |
| If needed, | Yes | | |
| have experts | | | |
| been | | | |
| consulted for | | | |
| input? | | | |
| Existing | | • | Activate feature toggles |
| features or | | | UQM_INTEGRATION_VIEW_MODE_FILTER_MENU : ON |
| components | | | UQM_INTEGRATION_VIEW_MODE_FILTER_MENU_PAGE_SE |
| that are | | | CTION : ON |
| affected by | | | |
| new feature | | | |
| Functional | Page filter Section available in the Vertical Bar in : | | |
| Correctness | | • | Edit Mode |
| | | • | View Mode |

--------------------------------------------------

| | |
|---|---|
| a. | Check the rename of the |

| | Story filter Section : from “Applied to All” to “Applied to All Pages” |
|---|---|
| • | New Story2.0 |
| • | Previous Story2.0 |

| | |
|---|---|
| b. | Check design of the Page |

| | filters Section : |
|---|---|
| • | 2nd section, after ‘Applied to All’ |
| • | Name : ‘Applied to This page’ |
| • | number of non-hidden filters in the section after the section name |
| | between parenthesis following by a with infotext on mouse over for |
| | information about this section |
| • | by default, it's expanded for the current page. It can be collapsed. |
| • | it's not visible when empty |
| • | a scroll bar should be available when there are more filters to be |

displayed
NB : * In View mode, it's impossible to add new page filter

| | |
|---|---|
| c. | Check the content of the |

| | section : |
|---|---|
| • | Page filter section named ‘Applied to this page’ showing all the page |
| | filters (and exposed variables) |
| • | a filter row per filter (name + filter summary, tooltip on mouse over, |

error/warning state (icon + summary + tooltip), state management:
blue background, delete button, individual reset button. (the filter
summary is made of current filter information + control panel filter
additional information) for the following filter types :

| | |
|---|---|
| ∘ | dimension/property : |

| | |
|---|---|
| ▪ | date selection/range |
| ▪ | current date input control (negative tests) |
| ▪ | numeric selection |
| ▪ | text selection/range |
| ▪ | advanced filters |
| ▪ | variable prompts (negative tests) |

| ∘ | linked analysis Input Control (negative tests) |
|---|---|
| ∘ | hyperlink filters (negative tests) ? |
| ∘ | widget Input Controls (calculation, dimension, measure) |
| | (negative tests) |
| ∘ | geomap filters thru sub-sections (‘All layers', ‘layer X (1 to |

N)’) (negative tests)

| • | Filters should be displayed in the same order as in the horizontal bar |
|---|---|
| | (left to right → top to bottom) |
| • | After changing the filter selection, the new filter values should be |
| | correctly displayed and persisted (after expanding/collapsing the filter / |
| | after closing and reopening the filter panel / after Pin to Top and Pin to |
| | Bottom) |
| • | the filter section is empty when none valuable page filter exists in the |

canvas

| | |
|---|---|
| d. | Check that the user can |

| | perform the following actions from the section |
|---|---|
| • | Expand and collapse any displayed filter |
| • | The user should be able to modify the filter selection (search for |
| | values, select, deselect) |
| • | “Modify” and “Delete” buttons (if authorized) |
| • | “Paste filter values” button for filters with a member selection (flat |
| | dimension only, no hierarchy) |
| • | Filter reset (if authorized) |

When the user moves to another page, the section content is updated
accordingly

| | |
|---|---|
| e. | For each kind of filters, |

check actions/interactions made in the canvas are reported in the page
section filter, and vice-versa

| | |
|---|---|
| f. | Check the behavior of the |

vertical filter panel is not altered by this section and relevant
actions/interactions

| | |
|---|---|
| g. | Check undo/redo |

| | behaviour for : |
|---|---|
| • | filter change |
| • | other actions |

| | |
|---|---|
| h. | Check vertical bar in |

Zoom mode, Present mode (fullscreen) and embedded mode

| | |
|---|---|
| i. | Check ‘Controls' button |

decommissioned

| | |
|---|---|
| j. | Check Scripting Page |

Filters

| | |
|---|---|
| k. | Check Consumption in |

Light Weight Viewer : scope to be determined with LWV Team

| | |
|---|---|
| P&R Quality | N/A |
| Security | 1/ Actual description |
| | 2/ UX specs (222 pages) |
| | 3/ delivery sequence with 7 steps ( 39 pages ) |
| | 4/ [\hat{ }Filter Menu Scope Doc 10-P8.pdf] (1 page) |
| | 5/ [\hat{ }VerticalPage.jpg] (1 page) |
| | [DEV / QA] Security Recommendations are ... |
| | ==> SEC-225 - Perform Input Validation |
| | ==> SEC-237 - Protect against Denial-of-Service attacks |
| | ==> SEC-281 - Make use of secure UI frameworks |
| | ... for the following graphical items |
| | UX specs :: Search field :: Pages [ 19 + 27 + 32 + 49 + 59 + 60 + 78 + 83 + |
| | 84 + 85 + 86 + 97 + 116 + 118 + 119 + 165 + 167 + 177 + 220 ] |
| | UX specs :: (5) Name field :: Pages [ 39 + 40 ] |
| | UX specs :: Paste Variable Values panel :: Page 85 |
| | UX specs :: Min and Max text fields :: Pages [ 90 + 93 + 144 ] |
| | UX specs :: km text field :: Page 144 |
| | UX specs :: Rank / Value text field :: Page 194 |
| | UX specs :: Opacity * field :: Page 215delivery sequence with 7 steps :: |
| | *Search field :: Pages [ 5+ 12 + 35] |
| Usage | N/A |
| Tracking | |
| Manageability | N/A |
| (e.g. ease of | |
| admin tasks) | |
| Translation | Verify that all texts are correctly translated. |
| Globalization | Internationalization: Support a right-to-left layout and bidirectional (bidi) |
| | text in input, display and printing? ( [GLOB-179] ), ONLY when this feature |
| | will be available |
| Deployment | N/A |
| Platform | N/A |
| Support | |
| Mobile | |
| Most | manual testing |
| Appropriate | |
| Testing | |
| Techniques | |
| Test | |
| Automation | |
| Strategy for | |
| Ongoing | |
| Regression | |
| Testing | |
| Accessibility | Standard behaviors for Keyboard Navigation+Focus and Horizon Theming. |
| | Check no regression regarding Belize Theming |
| ISO | |
| Third-Party | |
| (Open Source, | |
| Free, and | |
| Paid) | |
| OEM | |

The flexibility and scalability of the solution empower it to accommodate diverse projects and varying feature complexities within the tested solution. As the volume and complexity of features evolve, the model can be retrained and refined to align with the changing requirements. This adaptability ensures that the solution remains effective and relevant, regardless of the project scale or the evolving needs of the organization.

The iterative nature of the training process and the human validation feedback loop facilitate continuous learning and improvement of the AI model. Feedback from QA experts on generated test strategies helps refine the model, enhancing its accuracy, relevance, and understanding of the software solution's features and testing requirements. This iterative learning loop ensures a continuously evolving and improving AI model, resulting in increasingly effective test strategy generation over time. The present implementations embody a paradigm shift, leveraging AI and GPT-based models to revolutionize test strategy generation in the context of a given software solution (e.g., cloud analytics solution). The advantages it offers, include:
Enhanced Efficiency and Speed.
Comprehensive Functional Feature Coverage.
Consistency and Standardization.
Resource Optimization.
Scalability and Adaptability.
Continuous Learning and Improvement.

FIG. 2B shows a block diagram for an example of a process 250 for executing a test strategy to test the performance of a new feature of a software solution in accordance with implementations of the present disclosure. In some instances, the process 250 can be executed at a testing framework for testing software products.

At 255, a request to generate a test strategy for a new feature of a software solution is received. The request includes a specification of the new feature. In some instances, the specification of the new feature can be provided in a predefined format.

In some instances, the received request further includes at least one of: i) documents describing the feature, and/or ii) a list of previously technical issues and respective one or more provided solutions for each of the technical issues, wherein the previous technical issues are identified for features of the software solution that are different from the new feature. In some instances, the further information or data included in the received request can be provided based on obtaining such information from available resources for the software solution, from web resources (e.g., webpages), or based on obtaining the additional information from data storages including data for the new feature and/or the software solution. In some instances, when a previous version(s) of the software solution was executed, the performance can be monitored and data or tracked technical issues can be recorded, evaluated, and annotated with information for used solutions to address the respective technical issues.

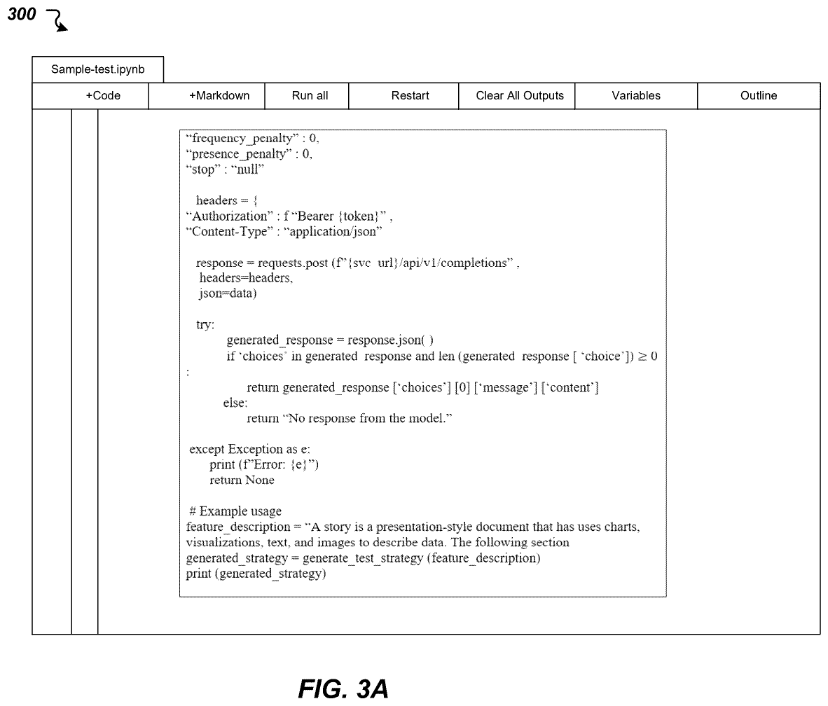

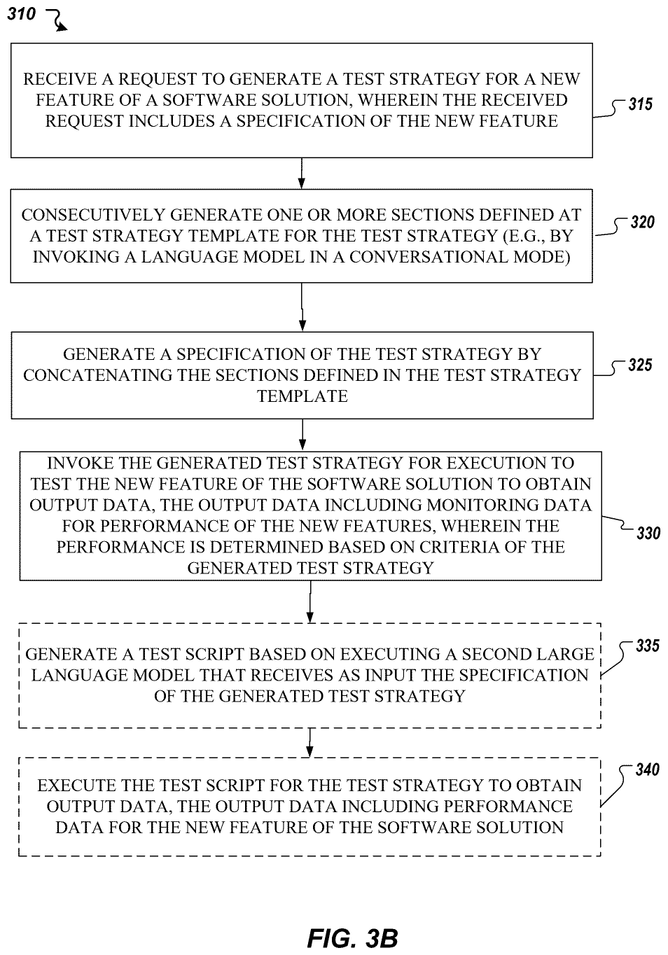

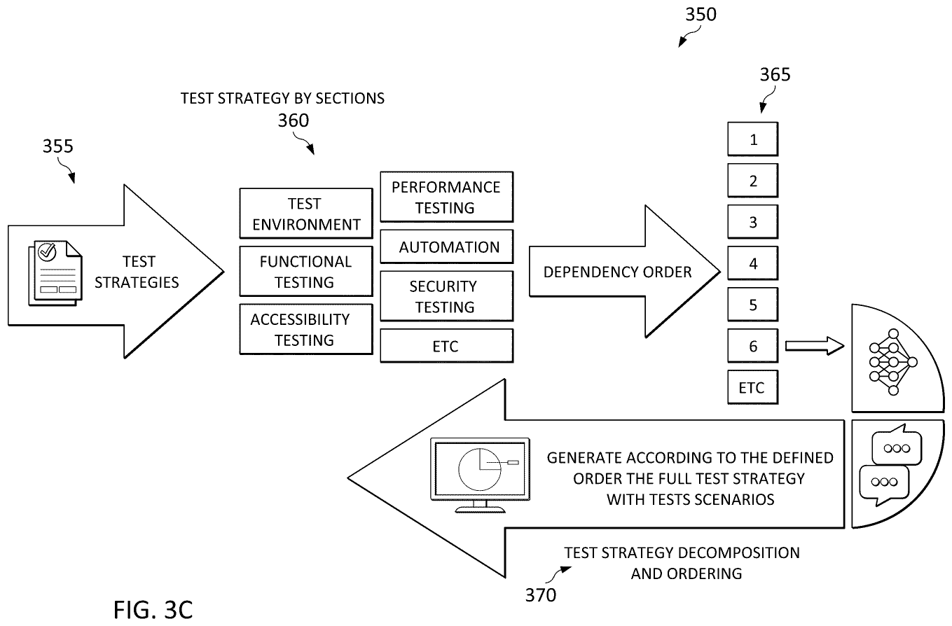

At 260, the test strategy can be generated by executing a large language model to automatically generate one or more test strategies based on technical documentation for the software solution, such as a test strategy template and legacy test strategies defined for the software solution. In some instances, the large language model can substantially match with the trained model 225 of FIG. 2A. In some instances, the large language model can be trained to generate the one or more test strategies in a predefined format. The predefined format can match with a format of the test strategy template that is used for the training of the model. The test strategy template can include a structure of a plurality of sections, where for each section, the test strategy template includes information indicative of required test strategy data for defining a test script for execution. In some instances, the generation of the test strategy can be performed section-by-section as described in relation to FIG. 3B. Table 2 below presents an example section of a test strategy template.

TABLE 2

| | |
|---|---|
| Quality Representative | Name |
| Quality Lead | Name |
| QL Signed Off | Yes/No/Comments? |
| Prioritized Risk Backlog with | Itemized list of risks including add probability and severity |
| mitigation plan | with corresponding mitigation plans |
| Test Approach | Guidelines should include: |

| • | What to pay attention to and consider in the test |
|---|---|
| | strategy |
| • | Level of testing |
| • | Who is responsible for what (e.g. end to end testing if |

applicable)

| | |
|---|---|
| Test Scope | List what is included and/or excluded in the test |
| Exploratory Test (with Tours) | List which tours (at least 1 tour) are to be executed. |
| | Test results to be record in the exploratory test template and |
| | attached to the product epic for reference. |

In some instances, the large language model that can be used to generate the test strategy at 260 can be trained based on training data, including data related to the software solution, the legacy test strategies as executed for an older version of the software solution that does not include the new feature and the test strategy template. The generated test strategy can serve as a foundational document to be provided for identifying subsequent steps for execution in a testing process running at a testing framework. In some instances, the generated test strategy can define at least one of a testing approach, methodologies, tools, and criteria necessary for comprehensive testing of the new feature.

In some instances, a specification of the generated test strategy can be generated to be used for the strategy execution. The specification can define actions and/or operations to be performed for the software solution to obtain the output data. In some instances, the specification for the generated test strategy can be for example, as shown in Table 3, where different sections in the test strategy are recorded with concrete actions related to expected input to determine the performance of the feature or software solution as a whole.

| Reference | Expectation | | | Responses |
|---|---|---|---|---|
| Is design described well in User | Yes/No/Comments? | | | |
| Story and well understood by | Clearly defines The role (who)? | | | |
| implementation team? | Clearly defines The feature (what)? | | | |
| | Clearly defines The reason (why)? | | | |
| If needed, have experts been | Yes/No/Comments? | | | |
| consulted for input? | | | | |
| Existing features or | | • | Itemized list of affect | |
| components that are affected | | | features/components. | |
| by new feature | | • | What Feature Toggles need to be on or | |

off while testing?

| | |
|---|---|
| XS Architectures | All features required to work on XSC with |
| | HANA 2 AND XSN with HANA Cloud as |
| | Customers purchase the same license for both. |
| | Have you considered XSC with HANA 2 AND |
| | XSN with HANA Cloud? |
| | Questions to consider: |

| • | Does your feature impact XS code? |
|---|---|
| • | Does your feature change |
| | communication between frontend and |
| | backend? |
| • | Does your feature generate/execute |
| | SQL against HANA database? |
| • | Does your feature use a new backing |
| | service? |
| • | Does your feature change interaction |

between a Java service and XS code?

| | |
|---|---|
| Manageability (e.g. ease of | Is manageability a concern/consideration as |
| admin tasks) | system grows? How is the customer/IT going |
| | to manage the features delivered in the epic? |
| Most Appropriate Testing | In addition to unit tests, should integration tests |
| Techniques | be automated? How about exploratory |
| | testing? System testing? Security testing? |
| Functional Correctness | How to guarantee functional correctness of the |
| | new feature? |
| | - boundary conditions and unhappy paths? |
| | For additional ideas please refer |
| | to the Functional Correctness Product |
| | Standard |

| • | What SAC tenant(s)/backend systems |
|---|---|
| | will be used for manual testing? If |
| | OEM affected what OEM tenant will be |
| | used for manual testing? |
| • | What data, models, will be used for |

manual testing? For additional ideas,
consider the feature use case and
attempt to obtain realistic data that
allows proper testing of the expected
Customer workflow.

| | |
|---|---|
| ∘ | Additionally please reference |

the “Test Automation Strategy
for Ongoing Regression
Testing” section, which defines
what type of model/data is
needed for test automation

| | | • | For live model testing, are the current |
|---|---|---|---|
| | | | backend systems already available and |
| | | | at the correct version? |
| Test Automation Strategy for | What should be automated and how? | | |
| Ongoing Regression Testing | | • | What model available in the build will |
| | | | be used for automation? Is a new model |
| | | | required? Can an existing model instead |
| | | | be modified? What kind of data is |
| | | | needed in the new model to support all |
| | | | the different types of automation that |
| | | | would be required? |
| P&R Quality | | • | What impact might the new feature |

| | have on core workflows' performance? |
|---|---|
| • | How should performance test scale the |
| | following attributes: Number of |
| | Threads, Size of Content, Complexity |
| | of Content and Single thread |
| | performance |
| • | P&R Test should take enough samples |
| | to ensure a stable measurement with |
| | low standard deviation |
| • | If necessary, tests should answer |
| | questions about CPU consumption, |
| | Memory Consumption, Bandwidth |
| | Consumption |
| • | Ensure you test in a customer |
| | representative environment with |
| | representative data/models to |
| | understand what our end-users will |
| | experience |
| • | Results always include Test Context |
| | (Landscape used, workflow tested, |
| | number of threads, number of samples |
| | or loops) |
| • | Avoid reporting average. Use median |

or 90th percentile

| | |
|---|---|
| | See P&R Test Strategy Approach and |
| | Development Team - Reporting Performance |
| | Test Results |
| Platform Support | What OS/browser/database/etc does the feature |
| | support? Please refer to the System |
| | Requirements and Technical Prerequisites |
| | Feature tested on which hyperscale providers |
| | (Azure, AWS, AliCloud, Neo, etc) or has no |
| | impact? |

| | |
|---|---|
| • | Generally speaking this is important for |

lower level features such as

| ∘ | Enabling a Custom SAML |
|---|---|
| | Identity Provider |
| ∘ | Configuring the SAPCP Cloud |
| | Connector |
| ∘ | Rearchitecting to move a feature |
| | from SAC Application Monolith |
| | to Service. |
| ∘ | Feature implemented in a new |

Service

| | | |
|---|---|---|
| Mobile | 1. | Any mobile impact? Check the Mobile |

| | Platforms Requirements for guidance |
|---|---|
| | on your risk assessment |
| 2. | New features from other team should |

consider impact to development mobile
version + previous mobile version
connecting to current orca scenario:

| 1. | if new feature OFF/ON will |
|---|---|
| | previous version mobile app |
| | works |
| 2. | if new feature ON/OFF will |

current version mobile app
works

| 3. | Will this create significant memory |
|---|---|
| | footprint? |
| 4. | Will this affect RenderComplete events |
| | being fired. |
| 5. | Have you discussed with mobile team |

who owns what area to test going
forward?

| | |
|---|---|
| | For additional ideas please refer to |
| | the Accessibility Product Standard |
| Operations & Support | Deployment |
| | Any special steps required during deployment |
| | in order to have the features enabled/working |
| | correctly? |
| | Is a new tenant or system classification needed |
| | (e.g. XXX Trial)? |
| | From Operations & Support Product Standard |

| | |
|---|---|
| • | ITSAM-1 [O&S 1-1] Operations |

Information

| | |
|---|---|
| ∘ | The information to operate the |

components and scenarios of the
application shall be
documented.

| | |
|---|---|
| • | ITSAM-29 [O&S 1-3] Backup and |

Recovery

| | |
|---|---|
| ∘ | The component shall provide a |

concept for online backup and
consistent recovery.

| | |
|---|---|
| • | ITSAM-46 [O&S 2-3] Technical |

Configuration

| | |
|---|---|
| ∘ | The component shall provide its |

technical configuration in
standardized repositories /
interfaces.

| | |
|---|---|
| • | ITSAM-33 [O&S 3-1] Central |

Administration

| | |
|---|---|
| ∘ | The component shall provide a |

central web-based
administration UI.

| | |
|---|---|
| • | ITSAM-75 [O&S 2-23] Harmonized |

Cloud Landscape Information

| | |
|---|---|
| ∘ | The cloud application shall |

register in the central SAP
Landscape repository with
proper data quality and display
core landscape information in a
homogeneous way.

| | |
|---|---|
| • | ITSAM-79 [O&S 2-27] Deployment |

Management Integration

| | |
|---|---|
| ∘ | Cloud products shall provide |

integration points into their
transport or deployment
mechanisms.

For additional ideas please refer to the
Operations & Support Product Standard,
the Software Lifecycle Product Standard and
the Cloud Qualities
Usage Tracking
Is usage tracking needed? If so:

| • | The usage tracking guide is followed |
|---|---|
| | when tracking your feature |
| • | The following action types are tracked: |
| | addition/deletion, modification, refresh, |
| | menu navigation, one-way actions |
| • | When applicable, impact of every |
| | tracked action is provided by passing |
| | specific and consistent |
| | context/argument for the action |
| • | Any newly introduced major product |

area is usage tracked

When completing your feature, please
answering the following:

| • | Does your feature change the users' |
|---|---|
| | workflow or add new workflows? |
| • | If so, have you discussed which points |
| | should have usage tracking added or |
| | modified with your PM/PE and |
| | designer? |
| • | For more information please refer to |

What To Track guide section

| | |
|---|---|
| | Ensure End-to-end Performance Statistics are |
| | still functional |
| Services (Applies to Services, in | This page contains information for SAC |
| addition to all other criteria) | Epic/User Story test strategies. |
| | All services required to work with XSC + |
| | HANA 2 AND XSN + HANA Cloud as |
| | Customers purchase the same license for both. |
| | Have you considered hyperscale-provider- |
| | specific behaviours of backing services such |
| | as Redis, Postgres, Solace, etc? |
| Accessibility | Please refer to Accessibility |
| | For additional ideas please refer to the UX |
| | Design Guidance for DoR and |
| | the Accessibility Product Standard |

TABLE 3

| | |
|---|---|
| Translation | Mandatory |

| • | Translation: Translations follow the |
|---|---|
| | SAP Language Strategy? (GLOB-188) |
| • | Internationalization: Text resource |
| | files use format supported by SAP |
| | translation tools? (GLOB-56) |
| • | Internationalization: Meta Data for |
| | Translator supplied? (GLOB-61) |
| • | Internationalization: Product is |

translatable? (GLOB-187)

If Applicable

| • | Translation: Development language is |
|---|---|
| | English? (GLOB-127) |
| • | Internationalization: Customer Data |
| | Translatable? (GLOB-64) |
| • | Internationalization: Translations |
| | traceable back to the original element? |
| | (GLOB-65) |
| • | Internationalization: Same Quality in |

all Languages? (GLOB-146)

| | |
|---|---|
| | SAC specific Translation |
| | For additional ideas please refer to the |
| | Developer Checklist |
| Globalization | Mandatory |

| • | Internationalization: Fully Unicode |
|---|---|
| | enabled which includes the ability to |
| | enter, process, store and print all |
| | Unicode characters? ( GLOB-94 ) |
| • | Internationalization: Works correctly |
| | across different time zones and during |
| | the daylight saving time switch? |
| | (consider storage and retrieval of |
| | date/times, not just timezone |
| | conversions. e.g. UTC time and how |
| | they are fetched and displayed) |
| | (GLOB-186 ) |
| • | Internationalization: Follow the |
| | independence status as defined in ISO |
| | 3166. Special attention shall be taken |
| | for Taiwan, Hong Kong and Macao? |
| | (GLOB-192) |
| • | Functional Localization: Functional |

localization for all supported countries
provided as outlined in the SAP
Country and Language Strategy?
(GLOB-188 )

If Applicable

| • | Internationalization: XML data |
|---|---|
| | transmitted in UTF-8? (GLOB-07) |
| • | Internationalization: Different paper |
| | sizes supported? ( GLOB-42 ) |
| • | Internationalization: Support of |
| | currency reforms (e.g. changeover to |
| | the Euro) ensured? ( GLOB-70 ) |
| • | Internationalization: Parallel usage of |
| | multiple currencies in the same country |
| | supported? ( GLOB-71 ) |
| • | Internationalization: Address formats |
| | and person name presentation |
| | adjustable to reflect user conventions in |
| | different countries? ( GLOB-74 ) |
| • | Internationalization: Functional |
| | localization can be implemented and |
| | maintained independently of other |
| | country versions? ( GLOB-81 ) |
| • | Internationalization: Support a right- |
| | to-left layout and bidirectional (bidi) |
| | text in input, display and printing? ( |
| | GLOB-179 ) |
| • | Internationalization: Data or file |
| | transfer done with the necessary code |
| | page conversion to ensure data |
| | integrity? (GLOB-183 ) |
| • | Internationalization: Currencies not |
| | hard-coded and meet international |
| | standards? (GLOB-185 ) |
| • | Internationalization: Japanese |
| | Emperor Calendar, Islamic Hijri |
| | Calendar, and the Persian Calendar |
| | supported in the UI and in date input? |
| | (GLOB-189 ) |
| • | Internationalization: Settings |
| | adaptable to user, browser or device |
| | specific settings: date-, time- and |
| | number format as well as time zone? |
| | (GLOB-190 ) |
| • | Functional Localization: Text data |
| | sorted following locale-specific |
| | (country- and language-specific) rules |
| | and conventions? ( GLOB-17 ) |
| • | Functional Localization: Same |
| | address can be maintained in a non- |
| | latin and a latin script? ( GLOB-75 ) |
| • | Functional Localization: The user |
| | interface provides the capability to |
| | display/hide country specific content? ( |
| | GLOB-82) |
| • | Functional |
| | Localization: Development tools |
| | delivered by SAP support the creation |
| | of internationalized applications? |
| | (GLOB-181 ) |
| • | Functional Localization: Legal |
| | compliance ensured for the target |
| | countries? (GLOB-182) |
| • | Functional Localization: Search |

algorithms support language specific
characteristics to avoid inaccurate or
incomplete search results? (GLOB-184
)

| | |
|---|---|
| ISO | To ensure ISO compliance please follow SAC |
| | Xray Documentation |
| Third-Party (Open Source, Free, | For ideas please refer to the Third Party |
| and Paid) | Process, the Open Source |
| | Process and the Licensing Product Standard. |
| OEM | OEM Specific Workflows to share with SAC |
| | teams |
| | For additional ideas please refer to |
| | the Integration Product Standard |

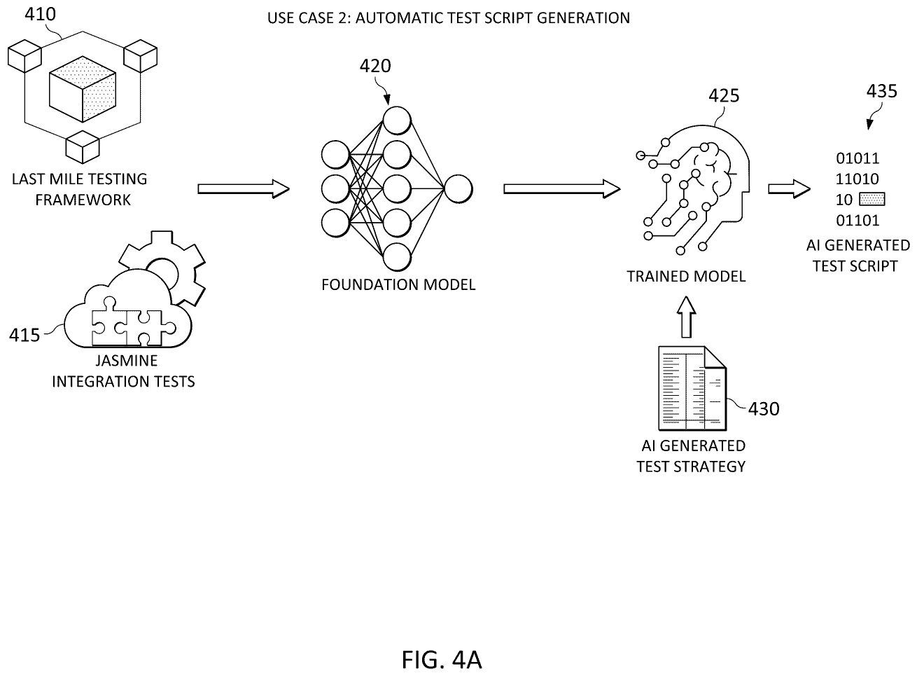

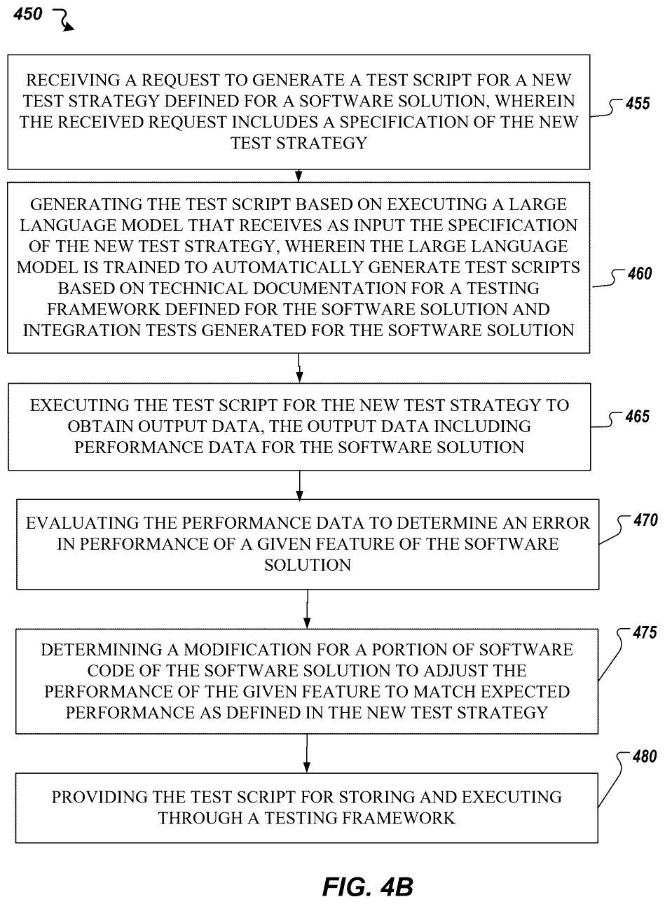

In some instances, a test script can be generated for the test strategy. The test script can be generated based on the specification of the generated test strategy. In some instances, the test script can be generated based on executing a second large language model that receives as input the specification of the generated test strategy, for example, as described in relation to FIGS. 4A and 4B. In some cases, the second large language model can be such as the trained model 425 of FIG. 4A and can be trained to automatically generate test scripts based on technical documentation for a testing framework defined for the software solution and integration tests generated for the software solution. To execute the test strategy, the test script can be executed and output data can be generated. The output data can include performance data for the new feature of the software solution.

At 265, the generated test strategy for the new feature of the software solution can be executed to obtain output data. The output data can include monitoring data for performance of the new feature, the performance of the new feature being determined based on criteria of the generated test strategy.

In some instances, based on the obtained output data from the execution of the test strategy, one or more processes for evaluation of the results and determination of modifications of the software product can be performed to improve the quality of the software solution that includes a new feature. In some cases, the modifications can be related to the implementation of the new features itself. In some cases, the modifications can be related to the implementation of other portions of the software solution to integrate the functionality provided by the new feature into the functionalities provided by other pre-existing features of the software product. In some cases, as shown at 270, the monitoring data can be evaluated to determine an error in the performance of the new feature. At 275, a modification for a portion of the software code of the software solution can be determined to adjust the performance of the new feature to match the expected performance as defined in the generated test strategy.

FIG. 3A shows a block diagram including an example of a test 300 generated based on a trained large language model in accordance with implementations of the present disclosure. The example is of a test strategy for functional testing of a new feature, for example, as described in relation to FIGS. 2A and 2B. In some instances, the test strategy used for generating the test 300 can include the following actions for evaluating the functional performance of a given feature. In some instances, the test strategy can also be used to evaluate other performance aspects of the given features such as functionality of the software solution, security level (e.g., according to a security standard and requirements), performance with regard to time and resource utilization, and/or accessibility and localization compliance (e.g., according to a predefined criterion or specification).

As shown at 300, the test is generated based on a test strategy generated for an analytical solution that visualizes data and presents text and images in response to a user request for querying, filtering, sorting, aggregating, or otherwise manipulating data obtained from a database. The test strategy for the functionality related to a new feature of such an analytical tool can include the actions as shown in Table 4 below.

TABLE 4

| | |
|---|---|
| | Test strategy for the new feature in Product X: |
| 1. | Functional Testing: |
| - | Verify that all chart types, visualizations, text, and image elements are displayed correctly |
| | in the story. |
| - | Test the interactivity of the story elements, such as drill-down, filtering, and sorting. |
| - | Validate the accuracy of the data displayed in the charts and visualizations. |
| - | Test the integration of data displayed in the charts and visualizations. |
| - | Verify that the story can be shared and accessed by different users with appropriate access |
| | permissions. |
| | Test the collaboration features, such as comments, annotations, and discussion within the |
| | story. |

The example test is generated to include steps of verification of data types, visualization, images, etc.; test interactivity of elements within a given presentation flow (e.g., a story), test integration of data from various sources (e.g., data invoked from different databases and combined to provide analytic results), test of integration and collaboration between features and performing sharing and access from different users.

FIG. 3B shows a block diagram including an example of a process 310 for generating a test strategy section by section based on invoking a large language model, in accordance with implementations of the present disclosure. In some instances, the process 310 can be performed in relation to a defined testing procedure for testing software solutions or products, for example, through a testing framework. In some instances, the process 310 can be performed to generate a test strategy as described in relation to FIGS. 2A and 2B, where the generation of the strategy can be performed in an iterative manner based on invoking a language model. The iterative generation can be done for defined sections of the test strategy that are part of a strategy template relied upon by the language model training.

At 315, a request to generate a test strategy for a new feature of a software solution can be received. The received request can include a specification of the new feature. The received request can substantially match the received request 255 of FIG. 2B.

At 320, one or more sections defined at a test strategy template for a test strategy can be consecutively generated. The consecutive generation of the one or more sections can include invoking for each section, a large language model in a conversational mode for generating test strategy data for each section of the test strategy template. The large language model can be invoked based on providing data comprising technical documentation relevant for the respective section, data for the respective section from legacy strategies, and requests relevant to the respective section as defined in the test strategy template.

In some instances, when the test strategy is generated, a subsequent section of the test strategy is generated by invoking the generation of such section, as identified in the test strategy template at the large language model, where for the generation of the subsequent section, the previously generated section is also used as input to the large language model (e.g., as part of the prompt used to query the language model).

In some instances, the large language model can be trained to generate a test strategy section in a predefined format. The predefined format can match a format of a section in the test strategy template. The training can be based on training data, including data related to the software solution, previous test cases executed for an older version of the software solution that does not include the new feature, and the test strategy template. In some instances, the previous test cases executed for an older version(s) of the software solution (or a previous version of the new feature) can be formatted in sections according to the predefined format. At 325, a specification of the test strategy can be generated by concatenating the sections defined in the test strategy template.

At 330, the generated test strategy can be invoked for execution to test the performance of the functionality implemented for the new feature of the software solution to obtain output data. The output data can include monitoring data for performance of the new features. The performance is determined based on criteria of the generated test strategy.

At 335, a test script can be generated based on executing a second large language model that receives as input the specification of the generated test strategy. The second language model can be trained to automatically generate test scripts based on technical documentation for a testing framework defined for testing the software solution and integration tests generated for the software solution.

At 340, the test script can be executed for the test strategy to obtain output data. The output data includes performance data for the new feature of the software solution.

FIG. 3C is an example process 350 for generating a test strategy in a section-by-section mode in accordance with implementations of the present disclosure. The process 350 can be executed to perform section-by-section test strategy generation as described in relation to FIG. 3B.

In some instances, when a request to generate a test strategy for a software solution is received (355), the request is evaluated automatically (i.e., without user input) to identify a test strategy template relevant for the requested test strategy. For example, the request is related to a feature of a given software product, and thus, a test strategy template related to the software product can be identified. A set of sections of the template can be determined (at 360). For example, the sections can include:
Test environment
Functional testing
Performance testing
Automation
Security testing
Accessibility testing
Other

In some instances, a large language model can be trained to process such requests for test strategies, where the large language model can be invoked iteratively over the list of the sections identified for the test strategy. In some instances, the sections can be defined in a dependency order (at 365), where the large language model can be invoked for each section as identified according to the dependency order 365. In such a manner, the test strategy generation can be performed in a decomposed style and according to an order of sections defined based on their interdependencies.

In some instances, each section determined according to the dependency order can be generated (at 370) by invoking the large language model and providing the previously determined sections to enhance the relevance of the generated output per iteration, and to improve the accuracy since the generation considers dependencies between sections. The full test strategy can be generated by concatenating the separate sections according to the order and executing the test strategy at a running instance of the software solution that is tested.

In some instances, when considering a dependency order of generating sections of a test strategy, it may be possible to consider the dependency order as defined in historical test strategies that were executed to evaluate previous version of the software solution. In some instances, the dependency order can be determined to implement a new format for the test strategy, e.g., that can be input to the process and different from a legacy format/order.

FIG. 4A shows a block diagram of an example automatic test script generation process 400. In some instances, a large language model can be used to generate automatic tests for a specific testing framework. The model can be trained on an automatic testing framework built for a particular software product or solution that is tested with the testing framework. In some instances, test scenarios from a generated test strategy (e.g., as described in relation to FIG. 2A) can be used as prompts for a large language model (e.g., GTP LLM) to train the large language model to automatically generate test scripts, including steps, input data, expected results, and assertions.

With such an automatic test script generation process, multiple technical advantages can be achieved:
increases efficiency by automating the creation of test cases.
enhances test coverage by generating tests for various scenarios.
improves consistency and accuracy in test case creation.
employ the fine-tuned model to design robust test strategies.

In some instances, the large language model can be trained based on training data, including integration tests and a testing framework. The trained model can generate test scripts that are compliant with a particular testing framework (as the one used for the training).

FIG. 4B shows a block diagram of an example execution 450 of a test strategy based on a test script that is generated based on invoking a large language model in accordance with implementations of the present disclosure.

At 455, a request to generate a test script for a new test strategy defined for a software solution is received. The request for the generation of the test script can be received for example after executing a process to define a new strategy for testing, as described in relation to FIGS. 2A. 2B, and 3B. The received request can include a specification of the new test strategy. In some instances, the generated test strategy can be generated as a whole based on invoking a language model or can be done as a section-by-section process as described in relation to FIG. 3B.

At 460, the test script can be generated based on executing a large language model that receives as input the specification of the new test strategy. In some instances, the large language model can be such as the trained model 425. In some instances, the language model can be trained to automatically generate test scripts based on technical documentation for a testing framework defined for the software solution and integration tests generated for the software solution.

At 465, the test script for the new test strategy can be executed to obtain output data. The output data includes performance data for the software solution. The obtained output data can include performance data for the new feature. The performance data is generated based on criteria for monitoring performance of the new feature according to the generated test strategy. In some instances, performance data includes data defining inaccurate output data from the software solution based on input data provided during the execution of the test script.

At 470, the performance data can be evaluated to determine an error in performance of a given feature of the software solution.

At 475, a modification for a portion of the software code of the software solution can be determined to be implemented so that when the modification is applied to the software code, the performance of the given feature can be adjusted to match the expected performance as defined in the new test strategy.

In some instances, the test script that is generated at 450 can be provided for storing and executing through a testing framework. In some instances, test results from executed tests based on a set of test scripts by a testing framework can be obtained. The test results can be used to determine one or more test scripts that had failed. In cases where a test script has failed, data descriptive of executions of the failed test script can be obtained and evaluated to determine a root cause for the failure. In some cases, the evaluation of the obtained test results can lead to a conclusion that the test script includes an error rather than the software solution that is tested. For example, such cases can occur when the testing framework is not synchronously updated to modify test executions based on modifications to the software product or other defined tests. In those cases, the test can be updated so that to properly test the functionality of the software solution. In some instances, in response to determining that a test script is executed successfully, the test script can be submitted for use when testing the functionality of the software solution at the testing framework.

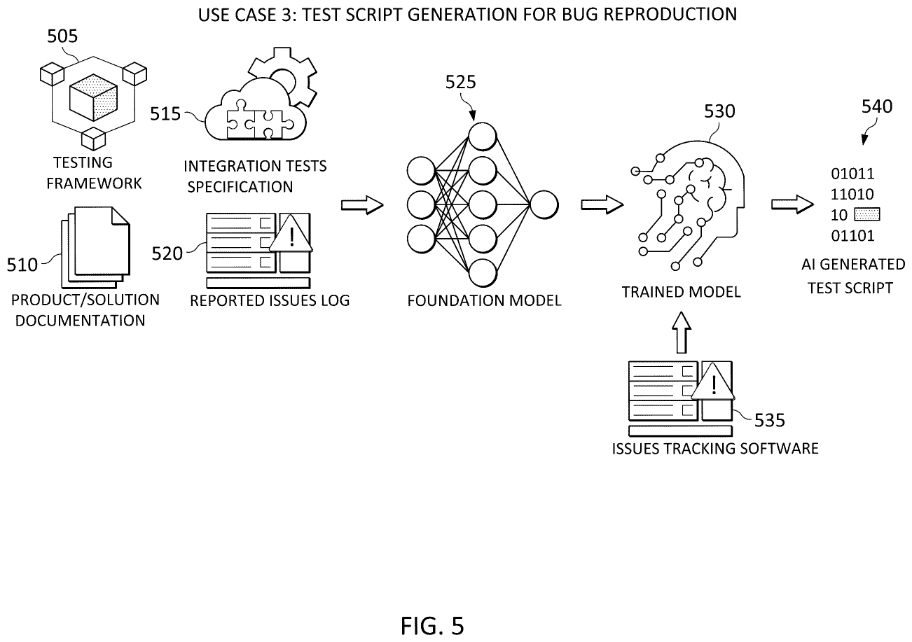

FIG. 5 shows a block diagram of an example test script generation process for bug reproduction. In some instances, a large language model 530 can be trained to generate test scripts for bug reproduction based on provided data including a description of an issue. For example, the large language model 530 can be trained to generate AI generated test scripts 540 that are relevant for reproducing issues and errors in a software product for the sake of executing test cases and obtaining performance data for the software product. Such performance data can be used to measure the performance quality of the software product and define further functionality to be implemented for the software product. In some instances, the AI generated test scripts 540 can be executed to simulate a production state of the software product in a given environment such as at a given cloud platform environment. In some instances, the generated test scripts 540 can be design to replicate performance issues at such particular environment to accurate evaluate the performance of the software application. In general, the AI generated test scripts 540 can be provided as prompt and accurate test base generated for a given product without manual input and based on observed behavior and patterns in performance at production environments.

In some instances, these test scripts can be automatically executed over a given software product or solution to reproduce test scenarios based on reported issues to validate whether the issue has been resolved with the new version of the software product. In some instances, the reported issues can be provided by an issue tracking software 535 that inputs tracked issues at a given environment, and associated with a given version of the software product to the trained model 530 to generate relevant test scripts as part of the AI generated test scripts 540.

In some instances, the large language model 530 can be trained based on training a foundation model using training data including information about a testing framework 505, integration tests specification 515, a solution or product documentation 510 (related to the product that is tested), and a reported issues log 530 that includes historically reported issues. The testing framework 505 can include previously created test scenarios (e.g., manually generated, recorded user interaction tests, automatically generated based on other techniques) and specific cases for resolving issues reported from users of the software product, including end users and/or quality specialists managing the software product lifecycle. Such test script generation techniques for bug reproduction can increase the efficiency of automating the generation of test cases that can be used to determine and resolve issues. With such techniques the test coverage for the software solution or product can be enhanced and consistency and accuracy of test case creation can be improved.

In some instances, a request to generate a test script for issues reproduction for a software solution can be received at the trained model 530. The received request can include a specification of the issue that is to be reproduced. The trained model 530 can generate a test script that is relevant for the software solution since the trained model 530 is trained on technical details for the functioning and configurations for a testing framework where the bug reproduction would be executed (i.e., the testing framework 505), integration test specification 515 and solution documentation that includes specifics for communication protocols and routines between the software solution and other related solutions or product, as well as specifics of internal procedures for the software solution (e.g., definition of data types, conversion requirements, size and load limitations, multi-threading, other). In instance, previously reported issues for at least one previous or current version of the software solution can also be leveraged into the training of the foundation model 525 to generate the trained model 530 so that the trained model can associate identified issues with route causes identifiable through analysis of the issues logs as well as information for the technical configuration and limitations of the software product. When a test script is generated for the receive request, the test script can be executed to reproduce the issue on a particular version of the software solution or at a test environment where an instance of the software solution is deployed for performance evaluation purposes to obtain output data including performance data for the particular version of the software solution. The obtained performance data for the version of the software solution can be used for triggering subsequent executions in the context of the lifecycle management of the software solution. For example, if the performance data indicate that the reproduced issue can be handled by the software solution without affecting an expected quality criterion for the solution, the particular version of the software solution can be released in productive model. In other examples, the performance data can be indicative of requirements for further developments or further test executions in relation to the particular version of the software solution. The automatic generation of test scripts for bug reproduction can support an efficient yet accurate system for determining the quality of a software product that simulates close to real production environment characteristics. The determination of the quality of the software product can support fast and computationally less expensive approach for generation of new version of software products that require less manual input and time resources.

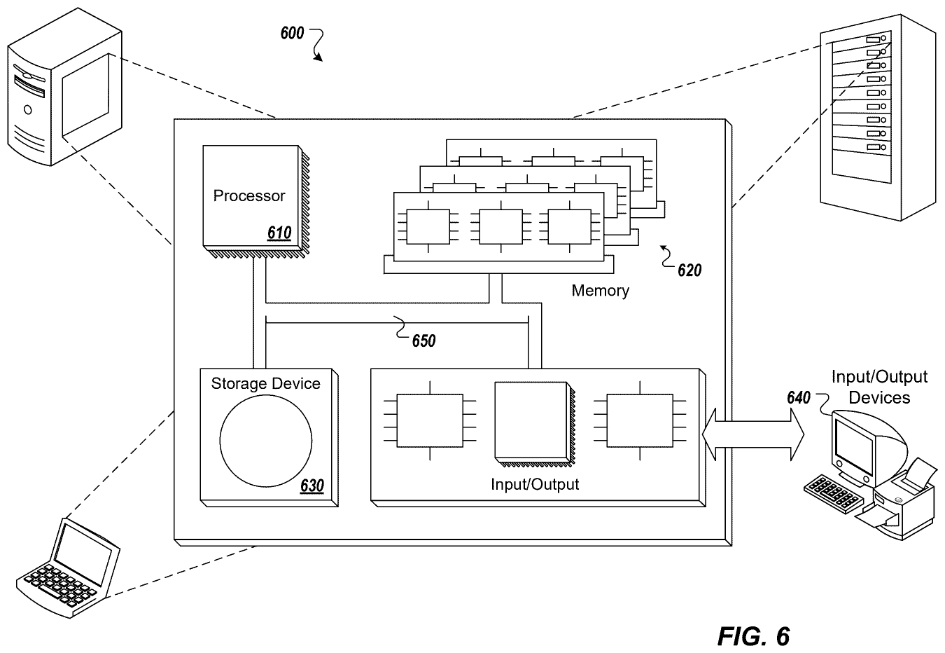

Referring now to FIG. 6, a schematic diagram of an example computing system 600 is provided. The system 600 can be used for the operations described in association with the implementations described herein. For example, the system 600 may be included in any or all of the server components discussed herein. The system 600 includes a processor 610, a memory 620, a storage device 630, and an input/output device 640. The components 610, 620, 630, and 640 are interconnected using a system bus 650. The processor 610 is capable of processing instructions for execution within the system 600. In some implementations, the processor 610 is a single-threaded processor. In some implementations, the processor 610 is a multi-threaded processor. The processor 610 is capable of processing instructions stored in the memory 620 or on the storage device 630 to display graphical information for a user interface on the input/output device 640.

The memory 620 stores information within the system 600. In some implementations, the memory 620 is a computer-readable medium. In some implementations, the memory 620 is a volatile memory unit. In some implementations, the memory 620 is a non-volatile memory unit. The storage device 630 is capable of providing mass storage for the system 600. In some implementations, the storage device 630 is a computer-readable medium. In some implementations, the storage device 630 may be a floppy disk device, a hard disk device, an optical disk device, or a tape device. The input/output device 640 provides input/output operations for the system 600. In some implementations, the input/output device 640 includes a keyboard and/or pointing device. In some implementations, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method operations can be performed by a programmable processor executing a program of instructions to perform functions of the described implementations by operating on input data and generating output. The described features can be implemented advantageously in one or more computer programs that are executable on a programmable system, including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory, a random access memory, or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a cathode ray tube (CRT) or liquid crystal display (LCD) monitor for displaying information to the user and a keyboard and a pointing device, such as a mouse or a trackball, by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other operations may be provided, or operations may be eliminated, from the described flows, and other components may be added to, or removed from the described systems. Accordingly, other implementations are within the scope of the following claims.

A number of implementations of the present disclosure have been described.

Nevertheless, it will be understood that various modifications may be made without departing from the spirit and scope of the present disclosure.

### EXAMPLES

Although the present application is defined in the attached claims, it should be understood that the present invention can also (additionally or alternatively) be defined in accordance with the following examples:

### Test Strategy Execution

Example 1. A computer-implemented method comprising:
receiving a request to generate a test strategy for a new feature of a software solution, wherein the received request includes a specification of the new feature;
generating the test strategy by executing a large language model to automatically generate one or more test strategies based on technical documentation for the software solution, a test strategy template, and legacy test strategies defined for the software solution; and
executing the generated test strategy for the new feature of the software solution to obtain output data including monitoring data for performance of the new features based on criteria of the generated test strategy.

Example 2. The method of Example 1, comprising:
training the large language model to generate the one or more test strategies in a predefined format, wherein the predefined format matches with a format of the generated test strategy template, and wherein the training is based on training data including data related to the software solution, previous test cases executed for an older version of the software solution that does not include the new feature, and the generated test strategy template.

Example 3. The method of any one of the preceding Examples, wherein the specification of the new feature is provided in a predefined format.

Example 4. The method of any one of the preceding Examples, wherein the generated test strategy defined at least one of a testing approach, methodologies, tools, and criteria necessary for comprehensive testing of the new feature.

Example 5. The method of any one of the preceding Examples, wherein the generated test strategy serves as a foundational document to be provided for identifying subsequent steps for execution in a testing process running at a testing framework.

Example 6. The method of any one of the preceding Examples, wherein executing the generated test strategy comprises:
receiving a request to generate a test script for the generated test strategy, wherein the received request includes a specification of the generated test strategy;
generating the test script based on executing a second large language model that receives as input the specification of the generated test strategy, wherein the large language model is trained to automatically generate test scripts based on technical documentation for a testing framework defined for the software solution and integration tests generated for the software solution; and
executing the test script for the test strategy to obtain output data including performance data for the new feature of the software solution.

Example 7. A computer-implemented method comprising:
receiving a request to generate a test script for a new test strategy defined for a software solution, wherein the received request includes a specification of the new test strategy;
generating the test script based on executing a large language model that receives as input the specification of the new test strategy, wherein the large language model is trained to automatically generate test scripts based on technical documentation for a testing framework defined for the software solution and integration tests generated for the software solution; and
executing the test script for the new test strategy to obtain output data including performance data for the software solution.

Example 8. The method of Example 7, wherein the new test strategy is the test strategy generated at method 1.

Example 9. The method of Example 7, wherein the performance data include data defining inaccurate output data from the software solution based on a test input identified in the test script.

Example 10.A computer-implemented method comprising:
receiving a request to generate a test script for issues reproduction for a software solution, wherein the received request includes a specification of an issue;
generating the test script based on executing a large language model that is trained to automatically generate test scripts based on technical documentation for a testing framework defined for the software solution, integration tests generated for the software solution, technical documentation for the software solution, and previously reported issues for at least one previous or current version of the software solution; and
executing the test script for the issue reproduction to reproduce the issue on a particular version of the software solution to obtain output data including performance data for the particular version of the software solution.

Example 11.A system comprising:
one or more processors; and
one or more computer-readable memories coupled to the one or more processors and having instructions stored thereon that are executable by the one or more processors to perform the method of any of Examples 1 to 10.

Example 12. A non-transitory, computer-readable medium coupled to one or more processors and having instructions stored thereon which, when executed by the one or more processors, cause the one or more processors to perform the method of any of Example 1 to 10.

### AI-Driven Test Case Generation for Functional Feature Coverage

Example 1. A computer-implemented method comprising:
receiving a request to generate a test strategy for a new feature of a software solution, wherein the received request includes a specification of the new feature;
generating the test strategy by executing a large language model to automatically generate one or more test strategies based on technical documentation for the software solution, a test strategy template, and legacy test strategies defined for the software solution; and
executing the generated test strategy for the new feature of the software solution to obtain output data, the output data including monitoring data for performance of the new feature, and the performance of the new feature being determined based on criteria of the generated test strategy.

Example 2. The method of Example 1, wherein the received request further includes at least one of: i) documents describing the feature, ii) a list of previously technical issues and respective one or more provided solutions for each of the technical issues, wherein the previous technical issues are identified for features of the software solution that are different from the new feature.

Example 3. The method of any one of the preceding Examples, comprising:
evaluating the monitoring data to determine an error in the performance of the new feature; and
determining a modification for a portion of software code of the software solution to adjust the performance of the new feature to match expected performance as defined in the generated test strategy.

Example 4. The method of any one of the preceding Examples, comprising:
training the large language model to generate the one or more test strategies in a predefined format, wherein the predefined format matches with a format of the test strategy template, and wherein the training is based on training data including data related to the software solution, the legacy test strategies as executed for an older version of the software solution that does not include the new feature, and the test strategy template.

Example 5. The method of any one of the preceding Examples, wherein the specification of the new feature is provided in a predefined format.

Example 6. The method of any one of the preceding Examples, wherein the generated test strategy defines at least one of a testing approach, methodologies, tools, and criteria necessary for comprehensive testing of the new feature.

Example 7. The method of any one of the preceding Examples, wherein the generated test strategy serves as a foundational document to be provided for identifying subsequent steps for execution in a testing process running at a testing framework.

Example 8. The method of any one of the preceding Examples, wherein executing the generated test strategy comprises:
generating a specification of the generated test strategy, wherein the specification defines actions and/or operations to be performed for the software solution to obtain the output data;
receiving a request to generate a test script for the generated test strategy, wherein the received request includes the specification of the generated test strategy;
generating the test script based on executing a second large language model that receives as input the specification of the generated test strategy, wherein the large language model is trained to automatically generate test scripts based on technical documentation for a testing framework defined for the software solution and integration tests generated for the software solution; and
executing the test script for the test strategy to obtain new output data, the new output data including performance data for the new feature of the software solution.

Example 9. The method of any one of the preceding Examples, wherein the test strategy template includes a structure of a plurality of sections, where for each section, the test strategy template includes information indicative of required test strategy data for defining a test script for execution.

Example 10. The method of Example 9, wherein generating the test strategy comprises:
consecutively generating each section of the plurality of sections defined at the test strategy template for the test strategy, wherein consecutively generating each section comprises:
   invoking, for each section, the large language model in a conversational mode for generating test strategy data for each section of the test strategy template, wherein invoking the large language model comprises providing data comprising technical documentation relevant for the respective section, respective sections of legacy strategies, and requests relevant to the respective section as defined in the test strategy template,
wherein the method further comprises:
generating a specification of the test strategy by concatenating the sections defined in the test strategy template.

Example 11.A system comprising:
one or more processors; and
one or more computer-readable memories coupled to the one or more processors and having instructions stored thereon that are executable by the one or more processors to perform operations according to the method of any one of Examples 1 to 10.

Example 12.A non-transitory, computer-readable medium coupled to one or more processors and having instructions stored thereon which, when executed by the one or more processors, cause the one or more processors to perform operations according to the method of any one of Examples 1 to 10.

### AI-Driven Section-by-Section Test Strategy Generation

Example 1. A computer-implemented method comprising:
receiving a request to generate a test strategy for a new feature of a software solution, wherein the received request includes a specification of the new feature;
consecutively generating one or more sections defined at a test strategy template for the test strategy, wherein consecutively generating the one or more sections comprises:
   invoking, for each section, a large language model in a conversational mode for generating test strategy data for each section of the test strategy template, wherein invoking the large language model comprises providing data comprising technical documentation relevant for the respective section, data for the respective section from legacy strategies, and requests relevant to the respective section as defined in the test strategy template;
generating a specification of the test strategy by concatenating the sections defined in the test strategy template; and
executing the generated test strategy for the new feature of the software solution to obtain output data, the output data including monitoring data for performance of the new features, wherein the performance is determined based on criteria of the generated test strategy.

Example 2. The method of Example 1, wherein the received request further includes at least one of: i) documents describing the feature, ii) a list of previously technical issues and respective one or more provided solutions for each of the technical issues, wherein the previous technical issues are identified for features of the software solution that are different from the new feature.

Example 3. The method of Example 1 or Example 2, wherein consecutively generating each section of the section comprises:
in response to generating a first section of the sections defined in the test strategy template, invoking the large language model to generate a second consecutive section based on a prompt including the generated first section.

Example 4. The method of any one of the preceding Examples, comprising:
training the large language model to generate test strategy sections in a predefined format, wherein the predefined format matches with a format of a section in the test strategy template, and wherein the training is based on training data including data related to the software solution, previous test cases executed for an least one older version of the software solution that does not include the new feature, and the test strategy template.

Example 5. The method of Example 4, wherein the previous test cases executed for the at least one older version of the software solution are formatted in sections according to the predefined format.

Example 6. The method of any one of the preceding Examples, wherein the specification of the new feature is provided in a predefined format.

Example 7. The method of any one of the preceding Examples, wherein the generated test strategy template includes sections defined for at least one of a testing approach, methodologies, tools, and criteria necessary for comprehensive testing of the new feature.

Example 8. The method of any one of the preceding Examples, wherein executing the generated test strategy comprises:
generating a test script based on executing a second large language model that receives as input the specification of the generated test strategy; and
executing the test script for the test strategy to obtain output data, the output data including performance data for the new feature of the software solution.

Example 9. The method of Example 8, wherein the second language model is trained to automatically generate test scripts based on technical documentation for a testing framework defined for testing the software solution and integration tests generated for the software solution.

Example 10.A system comprising:
one or more processors; and
one or more computer-readable memories coupled to the one or more processors and having instructions stored thereon that are executable by the one or more processors to perform operations according to the method of any one of Examples 1 to 7.

Example 11.A non-transitory, computer-readable medium coupled to one or more processors and having instructions stored thereon which, when executed by the one or more processors, cause the one or more processors to perform operations according to the method of any one of Examples 1 to 7.

### Augmented Test Execution Based on AI-Driven Test Script Generation

Example 1. A computer-implemented method comprising:
receiving a request to generate a test script for a new test strategy defined for a software solution, wherein the received request includes a specification of the new test strategy;
generating the test script based on executing a large language model that receives as input the specification of the new test strategy, wherein the large language model is trained to automatically generate test scripts based on technical documentation for a testing framework defined for the software solution and integration tests generated for the software solution; and
executing the test script for the new test strategy to obtain output data, the output data including performance data for the software solution.

Example 2. The method of Example 1, comprising:
receiving a request to execute a test for a new feature of the software solution, wherein the received request includes a specification of the new feature; and
generating a test strategy by executing a large language model to automatically generate one or more test strategies based on technical documentation for the software solution, a test strategy template, and legacy test strategies defined for the software solution, wherein the technical documentation includes a portion associated with the new feature of the software solution.

Example 3. The method of Example 2, wherein the obtained output data includes performance data for the new feature, wherein the performance data is generated based on criteria for monitoring performance of the new feature according to the generated test strategy.

Example 4. The method of any one of the preceding Examples, wherein the performance data include data defining inaccurate output data from the software solution based on input data provided during the execution of the test script.

Example 5. The method of any one of the preceding Examples, comprising:
evaluating the performance data to determine an error in performance of a given feature of the software solution; and
determining a modification for a portion of software code of the software solution to adjust the performance of the given feature to match expected performance as defined in the new test strategy.

Example 6. The method of any one of the preceding Examples, wherein the test script is generated to test one or more of i) functionality of the software solution, ii) security level, iii) performance with regard to time and resource utilization, and iv) accessibility and localization compliance, and wherein the method further comprises:
providing the test script for storing and executing through a testing framework.

Example 7. The method of Example 6, comprising:
in response to obtaining test results from executed tests based on a set of test scripts by the testing framework, the set of test scripts including the provided test script, evaluating the obtained test results to determine one or more tests scripts that had failed; and
obtaining data descriptive of executions of the one or more test scripts that had failed.

Example 8. The method of Example 7, comprising:
in response to determining that a test script of the one or more test scripts is executed successfully, submitting the test script for use when testing functionality of the software solution at the testing framework.

Example 9. A system comprising:
one or more processors; and
one or more computer-readable memories coupled to the one or more processors and having instructions stored thereon that are executable by the one or more processors to perform operations according to the method of any one of Example 1 to 8.

Example 10.A non-transitory, computer-readable medium coupled to one or more processors and having instructions stored thereon which, when executed by the one or more processors, cause the one or more processors to perform operations according to the method of any one of Example 1 to 8.

1. A computer-implemented method comprising:
receiving a request to generate a test strategy for a new feature of a software solution, wherein the received request includes a specification of the new feature;
consecutively generating one or more sections defined at a test strategy template for the test strategy, wherein consecutively generating the one or more sections comprises:
invoking, for each section, a large language model in a conversational mode for generating test strategy data for each section of the test strategy template, wherein invoking the large language model comprises providing data comprising technical documentation relevant for the respective section, data for the respective section from legacy strategies, and requests relevant to the respective section as defined in the test strategy template;
generating a specification of the test strategy by concatenating the sections defined in the test strategy template; and
executing the generated test strategy for the new feature of the software solution to obtain output data, the output data including monitoring data for performance of the new features, wherein the performance is determined based on criteria of the generated test strategy.

2. The method of claim 1, wherein the received request further includes at least one of: i) documents describing the feature, ii) a list of previously technical issues and respective one or more provided solutions for each of the technical issues, wherein the previous technical issues are identified for features of the software solution that are different from the new feature.

3. The method of claim 1, wherein consecutively generating each section of the section comprises:
in response to generating a first section of the sections defined in the test strategy template, invoking the large language model to generate a second consecutive section based on a prompt including the generated first section.

4. The method of claim 1, comprising:
training the large language model to generate test strategy sections in a predefined format, wherein the predefined format matches with a format of a section in the test strategy template, and wherein the training is based on training data including data related to the software solution, previous test cases executed for an least one older version of the software solution that does not include the new feature, and the test strategy template.

5. The method of claim 4, wherein the previous test cases executed for the at least one older version of the software solution are formatted in sections according to the predefined format.

6. The method of claim 1, wherein the specification of the new feature is provided in a predefined format.

7. The method of claim 1, wherein the generated test strategy template includes sections defined for at least one of a testing approach, methodologies, tools, and criteria necessary for comprehensive testing of the new feature.

8. The method of claim 1, wherein executing the generated test strategy comprises:
generating a test script based on executing a second large language model that receives as input the specification of the generated test strategy; and
executing the test script for the test strategy to obtain output data, the output data including performance data for the new feature of the software solution.

9. The method of claim 8, wherein the second language model is trained to automatically generate test scripts based on technical documentation for a testing framework defined for testing the software solution and integration tests generated for the software solution.

10. A system comprising:
one or more processors; and
one or more computer-readable memories coupled to the one or more processors and having instructions stored thereon that are executable by the one or more processors to perform operations comprising:
receiving a request to generate a test strategy for a new feature of a software solution, wherein the received request includes a specification of the new feature;
consecutively generating one or more sections defined at a test strategy template for the test strategy, wherein consecutively generating the one or more sections comprises:
invoking, for each section, a large language model in a conversational mode for generating test strategy data for each section of the test strategy template, wherein invoking the large language model comprises providing data comprising technical documentation relevant for the respective section, data for the respective section from legacy strategies, and requests relevant to the respective section as defined in the test strategy template;
generating a specification of the test strategy by concatenating the sections defined in the test strategy template; and
executing the generated test strategy for the new feature of the software solution to obtain output data, the output data including monitoring data for performance of the new features, wherein the performance is determined based on criteria of the generated test strategy.

11. The system of claim 10, wherein the received request further includes at least one of: i) documents describing the feature, ii) a list of previously technical issues and respective one or more provided solutions for each of the technical issues, wherein the previous technical issues are identified for features of the software solution that are different from the new feature.

12. The system of claim 10, wherein consecutively generating each section of the section comprises:
in response to generating a first section of the sections defined in the test strategy template, invoking the large language model to generate a second consecutive section based on a prompt including the generated first section.

13. The system of claim 10, comprising:
training the large language model to generate test strategy sections in a predefined format, wherein the predefined format matches with a format of a section in the test strategy template, and wherein the training is based on training data including data related to the software solution, previous test cases executed for an least one older version of the software solution that does not include the new feature, and the test strategy template.

14. The system of claim 13, wherein the previous test cases executed for the at least one older version of the software solution are formatted in sections according to the predefined format.

15. The system of claim 10, wherein the specification of the new feature is provided in a predefined format.

16. The system of claim 10, wherein the generated test strategy template includes sections defined for at least one of a testing approach, methodologies, tools, and criteria necessary for comprehensive testing of the new feature.

17. The system of claim 10, wherein executing the generated test strategy comprises:
generating a test script based on executing a second large language model that receives as input the specification of the generated test strategy; and
executing the test script for the test strategy to obtain output data, the output data including performance data for the new feature of the software solution.

18. The system of claim 17, wherein the second language model is trained to automatically generate test scripts based on technical documentation for a testing framework defined for testing the software solution and integration tests generated for the software solution.

19. A non-transitory, computer-readable medium coupled to one or more processors and having instructions stored thereon which, when executed by the one or more processors, cause the one or more processors to perform operations comprising:
receiving a request to generate a test strategy for a new feature of a software solution, wherein the received request includes a specification of the new feature;
consecutively generating one or more sections defined at a test strategy template for the test strategy, wherein consecutively generating the one or more sections comprises:
invoking, for each section, a large language model in a conversational mode for generating test strategy data for each section of the test strategy template, wherein invoking the large language model comprises providing data comprising technical documentation relevant for the respective section, data for the respective section from legacy strategies, and requests relevant to the respective section as defined in the test strategy template;
generating a specification of the test strategy by concatenating the sections defined in the test strategy template; and
executing the generated test strategy for the new feature of the software solution to obtain output data, the output data including monitoring data for performance of the new features, wherein the performance is determined based on criteria of the generated test strategy.

20. The non-transitory, computer-readable medium of claim 19, wherein the received request further includes at least one of: i) documents describing the feature, ii) a list of previously technical issues and respective one or more provided solutions for each of the technical issues, wherein the previous technical issues are identified for features of the software solution that are different from the new feature.
